(19) United States
(12) Patent Application Publication
(10) Pub. No.: US 2014/0091100 A1
(43) Pub. Date: Apr. 3, 2014

(54) Wind-Resistant Magnetic Trash Can

(71) Applicant: Yingjie Wan, Havertown, PA (US)

(72) Inventor: Yingjie Wan, Havertown, PA (US)

(21) Appl. No.: 13/631,813

(22) Filed: Sep. 28, 2012

(51) Int. Cl. B65F 1/14

(52) U.S. Cl. CPC B65F 1/141
USPC 220/636

(57) ABSTRACT

The present invention, The Wind-Resistant Magnetic Trash Can, can ensure the trash cans to overcome the shortcomings of the traditional trash cans which are easily been turned over by wind/animal through its build in magnetic plates.

### FIELD OF THE INVENTION

The present invention relates generally to a garbage can/trash can for household, office or public uses, and more particularly to a garbage can/trash can that provides with effective and convenient approach of preventing the garbage can/trash can from overturn, falling or lost by wind, or animal activities.

### BACKGROUND OF THE INVENTION

The traditional trash cans are usually molded plastic cans with wheels or plastic cans that can be transferred onto a carrier for easy transportation. In order to save material and cut down the cost, trash cans are made with less mass, hence are of light weight. Being light weighted yet maintaining substantial dimension simultaneously, the cans are unable to hold in place in a windy weather when the trash is not heavy enough, or after the cans have been emptied on trash picking days. Animals, such as raccoons, wild cats, etc. often would jump into trash cans to search for food and make the trash can to fall. Under severe weather condition, the wind blows the trash cans to the sidewalks, to the driveways, to the back yards, and most dangerously, to the streets and roads. This will not only soil the road or the house premise, leading to public hygienic problem, it can also result in traffic accidents that could damage motor vehicles and injure individuals. Not to mention the economic loss caused by losing the trash can when it is blown too far away and irretrievable.

### BRIEF SUMMARY OF THE INVENTION

It is, therefore, the primary objective of the present invention to provide an improved trash can design to overcome the shortcomings of the traditional trash cans described above.

In accordance with the principle of the present invention, the foregoing objective of the present invention, The Wind-Resistant Magnetic Trash Can, is achieved by an improved trash can set, which comprises of a trash can bottom, which contains magnetic material, and a separate flat plastic pad which also contains magnetic material, that will be buried underground prior to use.

The natural magnetic force between the magnetic material, which locates at the bottom of the trash can and the underground flat plastic pad at a specific location allows the trash can to be hold firmly upright at a specific place on the ground, and to avoid disturbance by the high speed wind under inclement, severe weather conditions or by the activities of the wild animals. It is extremely easy to install/handle the present design of Wind-Resistant Magnetic trash can; And the pair of magnetic plates lasts permanently, no worn-out, no energy consumption and/or maintenance required.

### BRIEF DESCRIPTION OF THE DRAWINGS

Attached are the drawings that illustrate the basic design and function of the present invention, the Wind-Resistant Magnetic Trash Can (Drawings provided here are to be regarded in all respects as merely illustrative and not restrictive. Drawings are not to scale).

FIG. 1 shows the 45 degrees view of the present invention.

FIG. 2 shows the front view of the present invention.

FIG. 3 shows the left side view of the present invention.

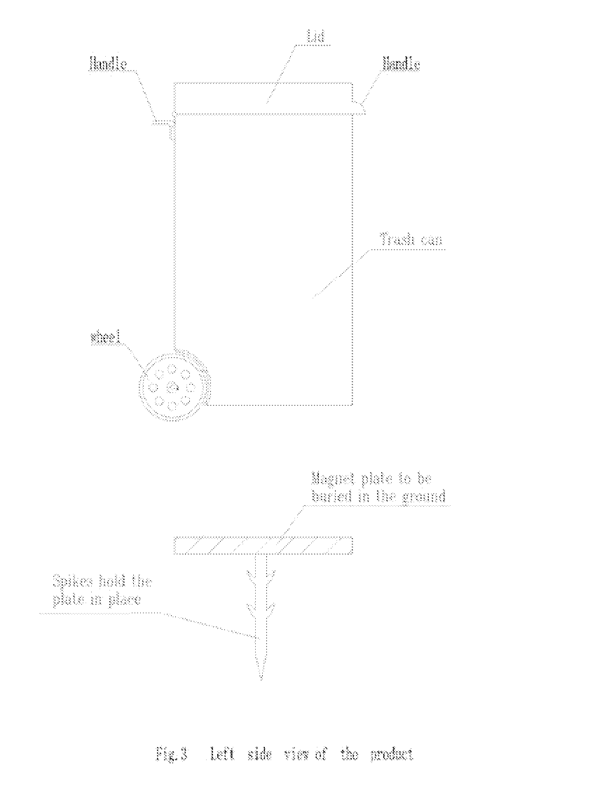

FIG. 4 shows the right view of the present invention.

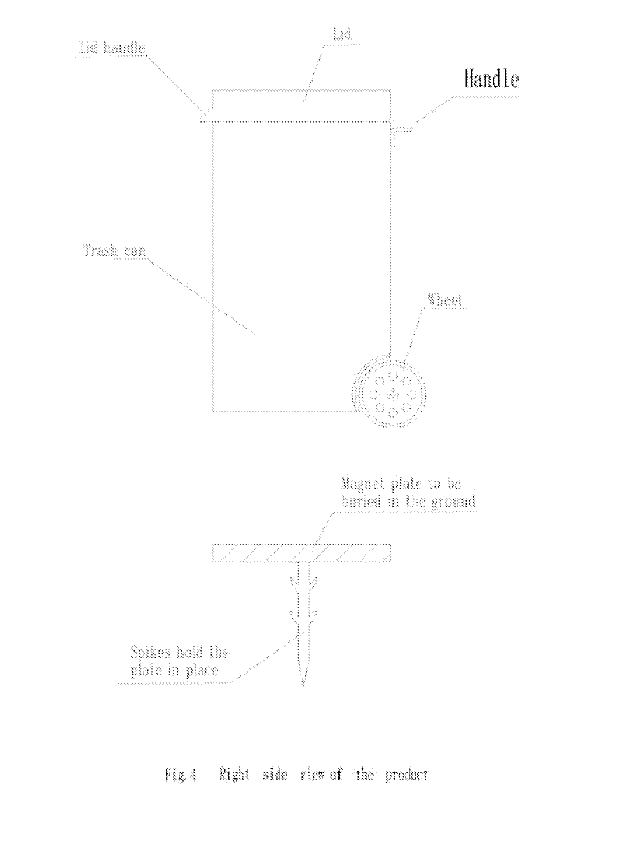

FIG. 5 shows the back view of the present invention.

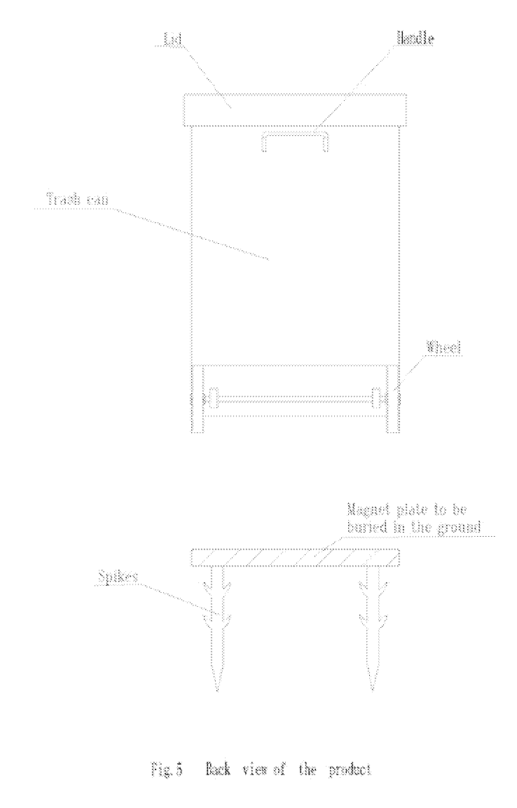

FIG. 6 shows the top view of the present invention.

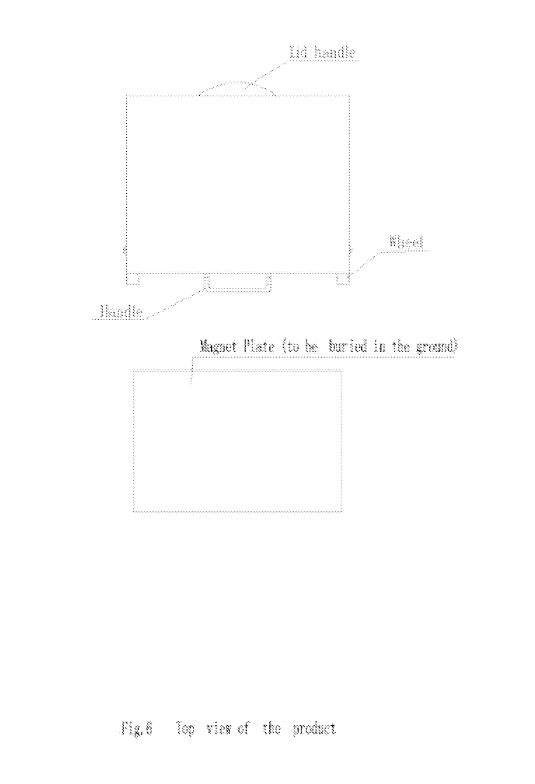

FIG. 7 shows the bottom view of the present invention.

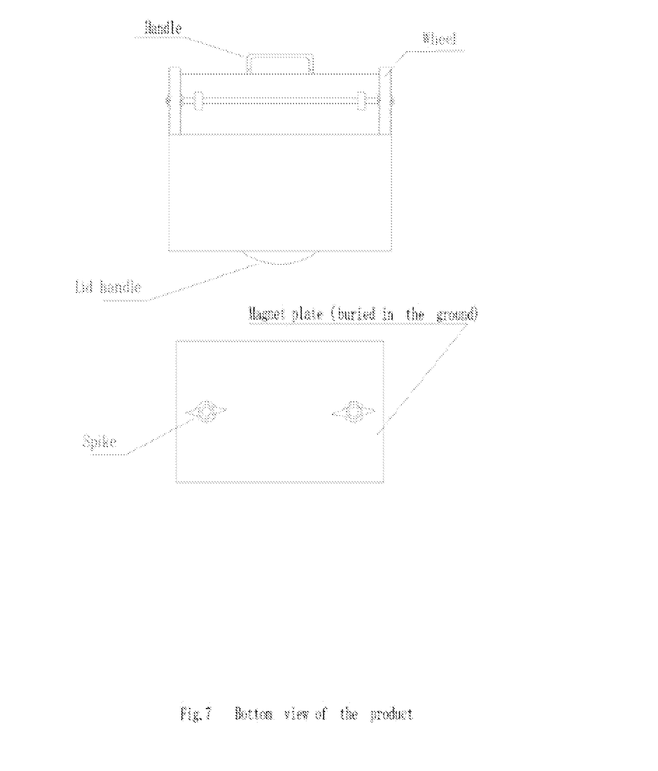

FIG. 8 shows the front view of the present invention when it holds onto the magnetic plate.

FIG. 9 shows the back view of the present invention when it holds onto the magnetic plate.

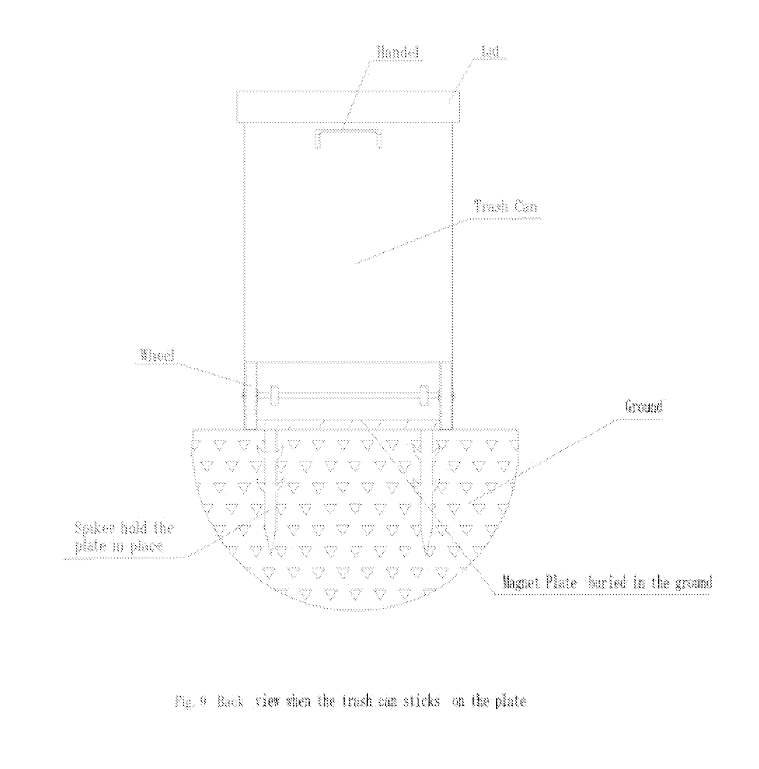

### DETAILED DESCRIPTION

Referring to all the drawings provided above, the present invention works effectively by pairing up a trash can and a flat plastic pad that locates under the ground, of which both contain magnetic material.

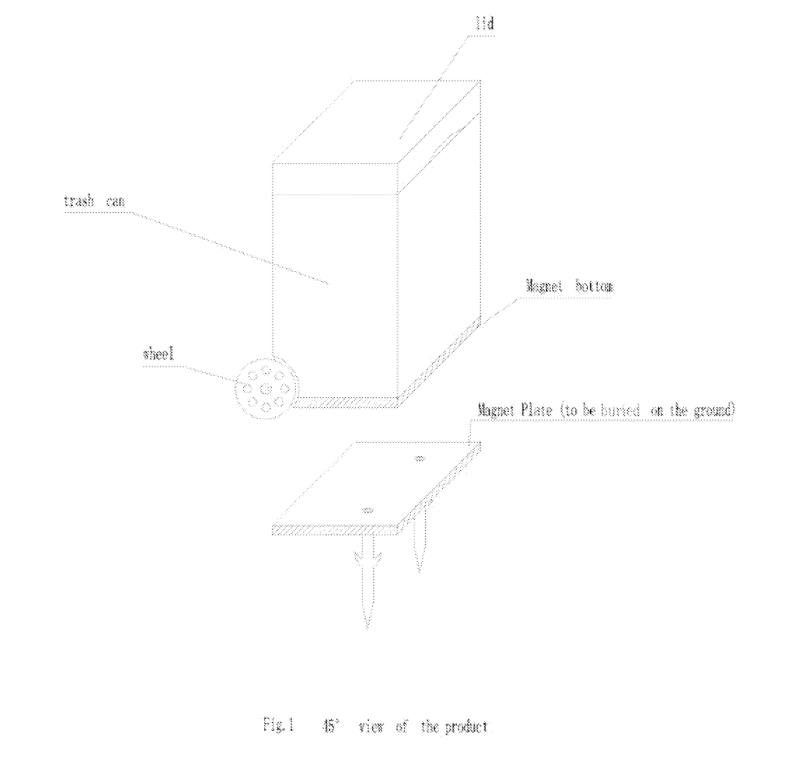

A magnetic plate is molded into the bottom part of the trash can during the manufacturing process. This plate is completely sealed by the building material (typically plastic) of the trash can. As shown in FIG. 1, and in the following drawings, the trash can's bottom (illustrated with shaded lines) is filled with magnetic plate.

Similarly, a magnetic plate is molded into a flat plastic pad during the manufacturing process. The magnetic plate is completely sealed by the building material of the pad. As shown in FIG. 1, and in the following drawings, the flat plastic pad (illustrated with shaded lines) is filled with magnetic plate.

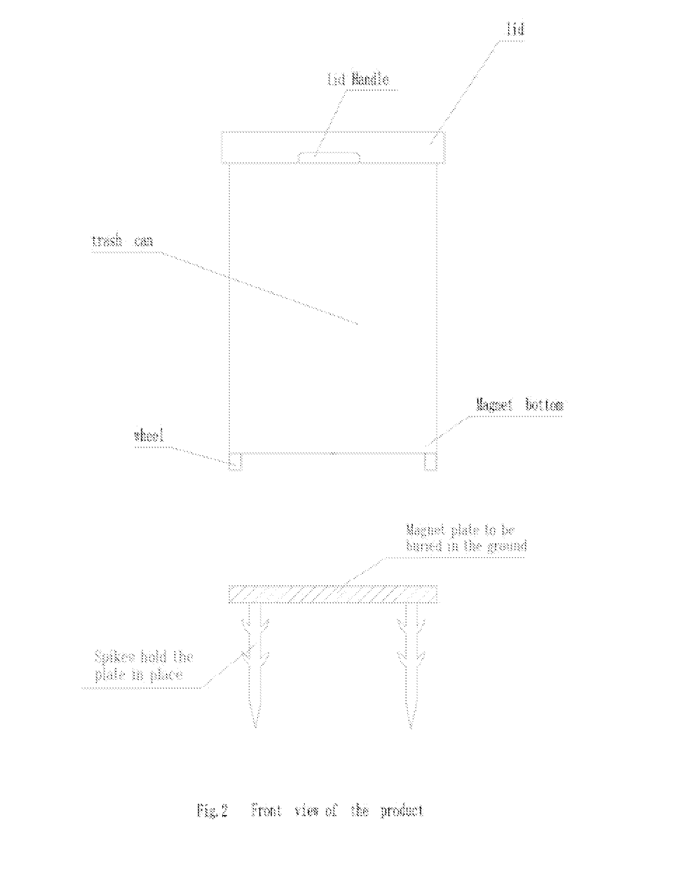

The flat plastic pad has multiple spikes with barbs (the spikes are screwed onto the flat plastic pad prior to installation of the flat plastic pad under the ground, and can be unscrewed during transportation, distribution and storage while the pad is not in usage), as shown at the lower portion in FIG. 2, and in the following drawings. The flat plastic pad can be buried easily under the ground at a location at each consumer's convenience, whether it being earth, cement or asphalt. The flat plastic pad holds tightly to the chosen positions by all the spikes onto which are screwed before installation. The flat plastic pad is even to the surface of the ground after installation/burying, it can be made with plastic with conspicuous colors or be painted with any color that the consumer desires for easy locating purpose. Multiple flat plastic pads can be buried along the curbs, in the back yards, and trash can storage areas to facilitate the utilization of the Wind-Resistant Magnetic Trash Can at a variety of locations.

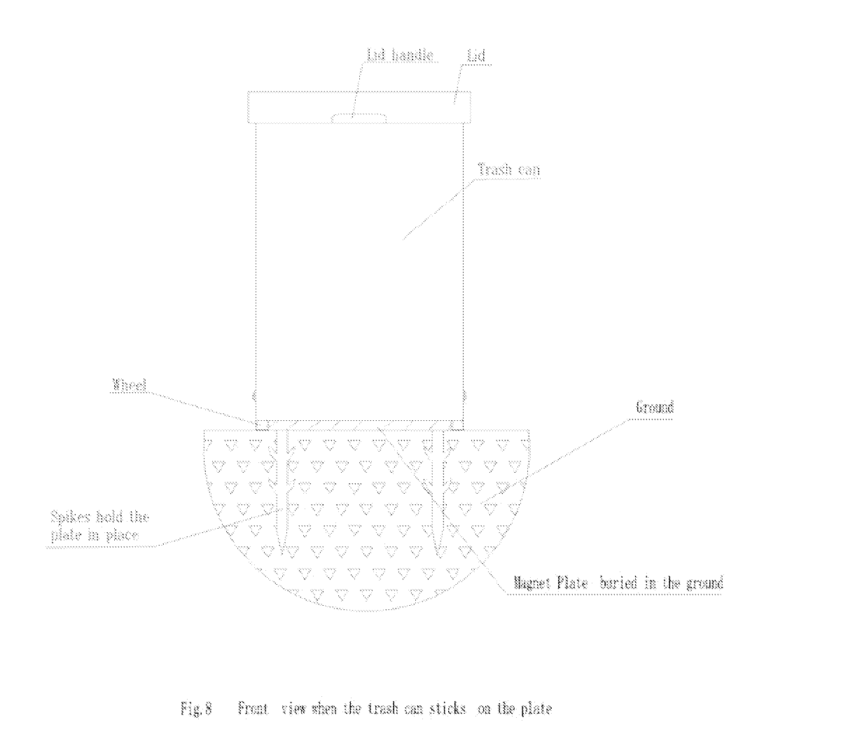

Typically, the consumer moves the trash can to the curb side, positions the trash can on top of the flat plastic pad which locates under the ground, permits the trash can to hold onto the flat plastic pad firmly. When the trash picking worker arrives, he/she pulls the trash can off the flat plastic pad with greater force and empties the trash can. Afterwards, the worker places the trash can back onto the flat plastic pad, allows the trash can to stand upright steadily through the suction force that supplied by the flat plastic pad. FIG. 1 shows the state in which the trash can is separated from the flat plastic pad, whereas the FIG. 8 shows the state where the trash can holds onto the flat plastic pad.

The trash can does not need to be precisely situated on top of the flat plastic pad to be held upright while in use; only a portion of this trash can's bottom holding onto the flat plastic pad would keep the trash can in place under most severe weather conditions, and prevent the animals from pushing down the trash can.

Furthermore, the same theory can be applied to modify the existing traditional trash cans which do not have a magnetic bottom.

A molded plastic pad containing magnetic material can be attached to an existing traditional trash can by bolts, screws, welding or gluing. Magnetic material is completely sealed by the building material of the plastic pad during the molding process. Once this plastic pad is attached to the bottom of a traditional trash can, it works identically as the Wind-Resistant Magnetic trash can.

When the flat plastic pad underground is no longer needed, it can be unearthed, recycled, and re-used at different locations if necessary.

1. The material of the magnet plate can be made of/comprised of any magnetic materials, include but not limited to magnetic metals, or magnetic alloy or magnetic ceramics, as long as the magnetic material provides sufficient magnet force to ensure the Wind-Resistant Magnetic Trash Can set functioning.

2. The building material of the Wind-Resistant Magnetic Trash Can can be any type of plastic that is appropriate for molding manufacturing and possesses sufficient strength, durability and weather proofing ability, appropriate for indoor and outdoor uses.

3. The recycled plastics can be used to manufacture the Wind-Resistant Magnetic Trash Cans.

4. The structure, dimension, shape, color and style of the Wind-Resistant Magnetic Trash Can can be variable.

5. The structure, dimension, shape, color and style of the magnetic material containing flat plastic pad which is buried under the ground can be variable.

6. The structure, dimension, shape, color and style of the magnetic material containing plastic plate which can be attached to an existing traditional trash can, can be variable.
